(19) United States
(12) Patent Application Publication
(10) Pub. No.: US 2026/0239381 A1
(43) Pub. Date: Aug. 13, 2026

(54) Contiguous Resource Block-Based Resource Pool for Sidelink

(71) Applicant: Apple Inc., Cupertino, CA (US)

(72) Inventors: Chunxuan YE, San Diego, CA (US); Chunhai YAO, Beijing (CN); Dawei ZHANG, Saratoga, CA (US); Haitong SUN, Saratoga, CA (US); Hong HE, San Jose, CA (US); Huaning NIU, San Jose, CA (US); Jie CUI, San Jose, CA (US); Wei ZENG, Saratoga, CA (US); Weidong YANG, San Diego, CA (US); Zhibin WU, Los Altos, CA (US)

(21) Appl. No.: 19/152,584

(22) PCT Filed: Feb. 2, 2023
(86) PCT No.: PCT/CN2023/074245

§ 371 Date: Jul. 31, 2025

(51) Int. Cl. H04W 72/25; H04L 1/1607; H04L 5/00

(52) U.S. Cl. CPC H04W 72/25; H04L 1/1614; H04L 5/0094

(57) ABSTRACT

A user equipment (UE) is configured to receive configuration information for a resource pool of a sidelink connection in an unlicensed frequency band, wherein the resource pool comprises a plurality of contiguous Physical Resource Blocks (PRBs), a first Resource Block (RB) set comprising a first subset of the PRBs, a second RB set comprising a second subset of the PRBs, and a guard band comprising a third subset of the PRBs and transmit a Physical Sidelink Control Channel (PSCCH) transmission or a Physical Sidelink Shared Channel (PSSCH) transmission using the resource pool.

### TECHNICAL FIELD

This application relates generally to wireless communication systems, and in particular relates to contiguous resource block-based resource pool for sidelink.

### BACKGROUND

Several areas of User Equipment (UE) sidelink behavior in the unlicensed spectrum remain undefined. One of these areas is a contiguous Resource Block (RB)-based Physical Sidelink Control Channel (PSCCH) or Physical Sidelink Shared Channel (PSSCH) transmission in the unlicensed spectrum. There may be several options regarding mapping between sub-channels and Physical Resource Blocks (PRBs) in the unlicensed spectrum. However, each of these options presents various issues that need to be resolved prior to implementing a solution.

### SUMMARY

Some exemplary embodiments are related to a method performed by a user equipment (UE). The method includes receiving configuration information for a resource pool of a sidelink connection in an unlicensed frequency band, wherein the resource pool comprises a plurality of contiguous Physical Resource Blocks (PRBs), a first Resource Block (RB) set comprising a first subset of the PRBs, a second RB set comprising a second subset of the PRBs, and a guard band comprising a third subset of the PRBs and transmitting a Physical Sidelink Control Channel (PSCCH) transmission or a Physical Sidelink Shared Channel (PSSCH) transmission using the resource pool.

Other exemplary embodiments are related to a processor of a user equipment (UE) configured to receive configuration information for a resource pool of a sidelink connection in an unlicensed frequency band, wherein the resource pool comprises a plurality of contiguous Physical Resource Blocks (PRBs), a first Resource Block (RB) set comprising a first subset of the PRBs, a second RB set comprising a second subset of the PRBs, and a guard band comprising a third subset of the PRBs and transmit a Physical Sidelink Control Channel (PSCCH) transmission or a Physical Sidelink Shared Channel (PSSCH) transmission using the resource pool.

### BRIEF DESCRIPTION OF THE DRAWINGS

FIG. 1 shows an exemplary network arrangement according to various exemplary embodiments.

FIG. 2 shows an exemplary UE according to various exemplary embodiments.

FIG. 3 shows an exemplary base station according to various exemplary embodiments.

FIG. 4 shows a first exemplary option for mapping between sub-channels and PRBs in a resource pool for sidelink communications in the unlicensed spectrum according to various exemplary embodiments.

FIG. 5 shows an exemplary diagram of an RB Set with contiguous PRBs having a guard band in the middle of a sub-channel of the RB Set according to various exemplary embodiments.

FIG. 6 shows a second exemplary option for mapping between sub-channels and PRBs in a resource pool for sidelink communications in the unlicensed spectrum according to various exemplary embodiments.

FIG. 7 shows a third exemplary option for mapping between sub-channels and PRBs in a resource pool for sidelink communications in the unlicensed spectrum according to various exemplary embodiments.

FIG. 8 shows a first alternative of the third exemplary option for addressing PSCCH transmissions in a guard band according to various exemplary embodiments.

FIG. 9 shows a second alternative of the third exemplary option for addressing PSCCH transmissions in a guard band according to various exemplary embodiments.

FIG. 10 shows a third alternative of the third exemplary option for addressing PSCCH transmissions in a guard band according to various exemplary embodiments.

FIG. 11 shows an example of Physical Sidelink Feedback Channel (PSFCH) configuration information for a contiguous RB-based resource pool according to various exemplary embodiments.

### DETAILED DESCRIPTION

The exemplary embodiments may be further understood with reference to the following description and the related appended drawings, wherein like elements are provided with the same reference numerals. The exemplary embodiments relate to solutions for contiguous Resource Block (RB)-based Physical Sidelink Control Channel (PSCCH) or Physical Sidelink Shared Channel (PSSCH) transmissions in a resource pool.

The exemplary embodiments are described with regard to a UE. However, reference to a UE is merely provided for illustrative purposes. The exemplary embodiments may be utilized with any electronic component that may establish a connection to an accessory device and is configured with the hardware, software, and/or firmware to exchange information and data with accessory devices. Therefore, the UE as described herein is used to represent any electronic component.

The exemplary embodiments are also described with reference to a 5G New Radio (NR) network. However, it should be understood that the exemplary embodiments may also be implemented in other types of networks, including but not limited to LTE networks, future evolutions of the cellular protocol (e. g., 6G networks), or any other type of network.

The exemplary embodiments are also described with reference to a sidelink connection. A sidelink connection may be generally understood as transmissions between UEs (e.g., phones, tablets, smartwatches, connected vehicles, etc.) without the need for a base station to transmit or receive data. Sidelink operations may be desirable in scenarios where ultra-low latency transmissions between connected devices are needed (e.g., connected vehicles).

The exemplary embodiments are described with reference to sidelink communications in the unlicensed spectrum. As those skilled in the art will understand, unlike the licensed spectrum, a UE transmitting in the unlicensed spectrum will perform a clear channel assessment procedure such as a listen before talk (LBT) operation prior to transmitting on the unlicensed spectrum. This adds a level of complexity to sidelink communications because in some cases, the LBT operation will fail and the UE will not be able to transmit using the desired resources.

Numerous areas of NR sidelink operations in the unlicensed spectrum may benefit from further definition. As used herein, an unlicensed spectrum may include, but is not limited to, a spectrum (e.g., frequency band) in which spectrum access is contention based. One of the areas is the UE transmission operations when a sidelink resource pool comprises a plurality of contiguous PRBs. Such a resource pool may include guard band PRBs that may not be used for transmissions or certain types of transmissions. When a UE is transmitting Physical Sidelink Control Channel (PSCCH) or Physical Sidelink Shared Channel (PSSCH) transmissions in such a resource pool, the UE behavior needs to be defined to account for the issues associated with such resource pools.

The exemplary embodiments provide various mechanisms to account for the issues associated with a contiguous PRB resource pool. These mechanisms include, but are not limited to, defining when PSCCH transmissions are allowed, when PSCCH transmissions should be stopped, when PSCCH transmissions are to be punctured, defining sub-channels in the resource pool and PRBs that belong or do not belong to the sub-channels, PRB mapping within the resource pool, RB Sets, and/or sub-channels and defining Physical Sidelink Feedback Channel (PSFCH) resources in the resource pool. These features and other features will be described below with reference to the exemplary embodiments.

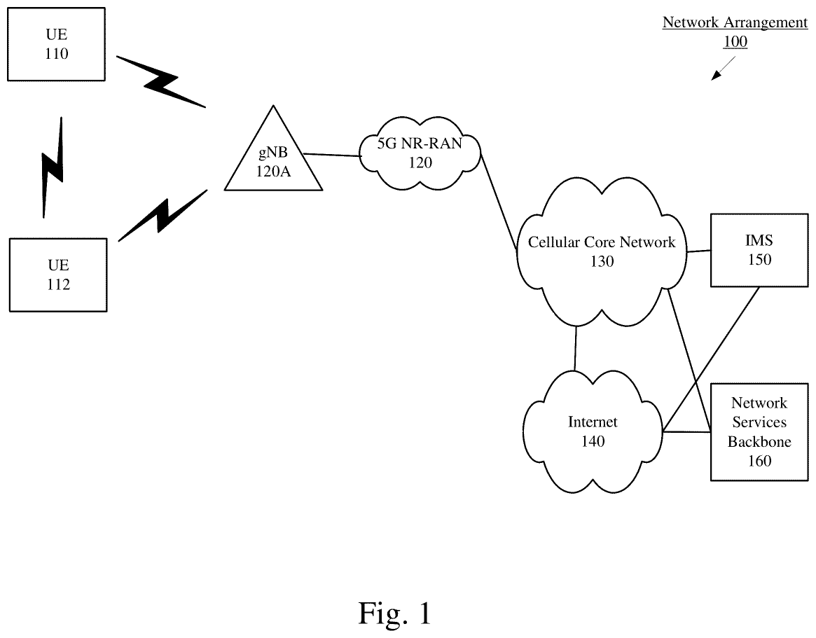

FIG. 1 shows an exemplary network arrangement 100 according to various exemplary embodiments. The exemplary network arrangement 100 includes a UE 110 and a UE 112. Those skilled in the art will understand that the UEs 110 and 112 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of two UEs 110 and 112 is merely provided for illustrative purposes. Further description will relate to UE 110, but it should be understood that all description of UE 110 is applicable to UE 112 throughout this disclosure.

The UE 110 may be configured to communicate with one or more networks. In the example of the network configuration 100, the network with which the UE 110 may wirelessly communicate is a 5G NR radio access network (RAN) 120. However, it should be understood that the UE 110 may also communicate with other types of networks (e.g., 5G cloud RAN, a next generation RAN (NG-RAN), a legacy cellular network, etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120. The UE 110 may also communicate with the UE 112 over an unlicensed sidelink connection, wherein data is exchanged between the UE 110 and the UE 112 without the gNB 120A.

The 5G NR RAN 120 may be portions of a cellular network that may be deployed by a network carrier (e. g., Verizon, AT&T, T-Mobile, etc.) . The RAN 120 may include cells or base stations that are configured to send and receive traffic from UEs that are equipped with the appropriate cellular chip set. In this example, the 5G NR RAN 120 includes the gNB 120A.

However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.).

Those skilled in the art will understand that any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., gNB 120A).

The network arrangement 100 also includes a cellular core network 130, the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

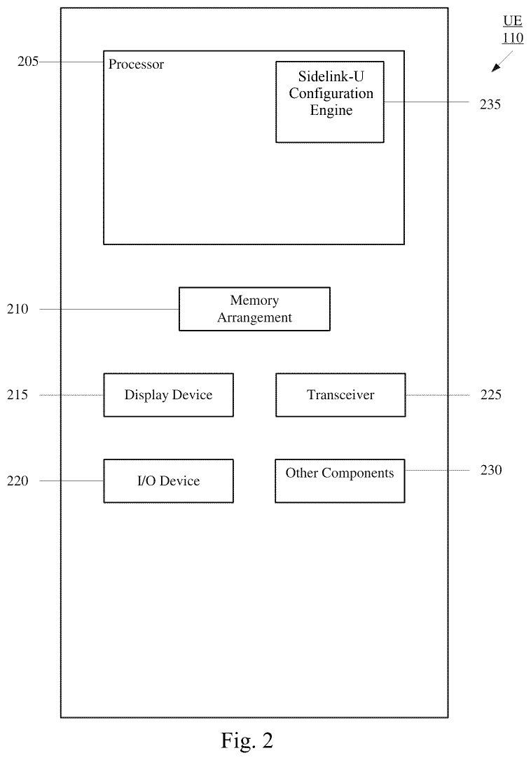

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230.

The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include an Sidelink-U Configuration Engine 235 for performing operations such as determining when to transmit PSCCH and PSSCH transmissions in the unlicensed spectrum.

The above referenced engine being an application (e. g., a program) executed by the processor 205 is only exemplary. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G-NR RAN 120. Accordingly, the transceiver 225 may operate on a variety of different frequencies or channels (e.g., set of consecutive frequencies).

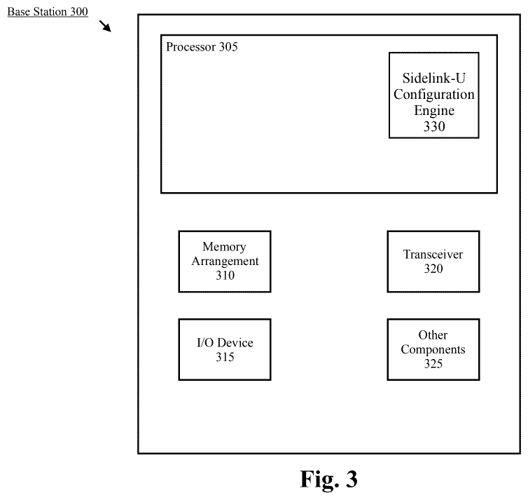

FIG. 3 shows an exemplary base station 300 according to various exemplary embodiments. The base station 300 may represent the gNB 120A or any other access node through which the UE 110 may establish a connection and manage network operations.

The base station 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines for the UE 110. For example, the engines may include a Sidelink-U Configuration Engine 330 for performing operations such as generating (pre) configurations a resource pool for sidelink communications.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e. g., radios) to enable the data exchange with the various networks and UEs.

As stated above, when there is a contiguous Resource Block (RB)-based Physical Sidelink Control Channel (PSCCH) or Physical Sidelink Shared Channel (PSSCH) transmission in the unlicensed spectrum, there may be several options regarding mapping between sub-channels and Physical Resource Blocks (PRBs) in the unlicensed spectrum. The following will describe the various options for the mapping, the issues related to the mapping and various solutions for the issues.

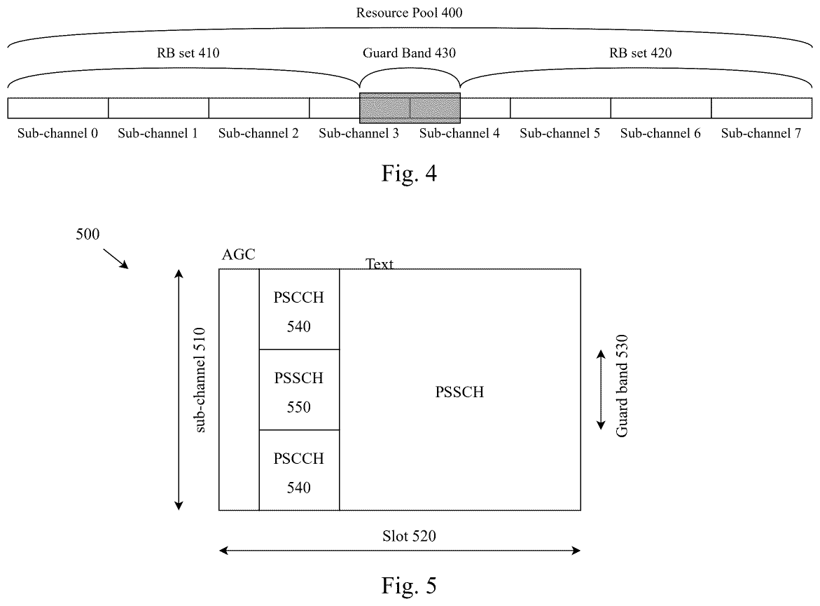

FIG. 4 shows a first exemplary option for mapping between sub-channels and PRBs in a resource pool 400 for sidelink communications in the unlicensed spectrum according to various exemplary embodiments. In the example of FIG. 4, a sub-channel aligns with a resource pool boundary. As will be described in greater detail below, the mapping of a sub-channel starts from a first PRB of the resource pool and is mapped sequentially within the resource pool according to the size of the sub-channel.

As shown in FIG. 4, the resource pool 400 comprises two RB sets (e.g., RB Set 410 and RB Set 420) that may be considered to occupy contiguous PRBs. Each of the RB Sets 410 and 420 comprise four (4) sub-channels, e. g., RB Set 410 includes sub-channels 0-3 and RB Set 420 includes sub-channels 4-7. In this example, each sub-channel is the same size, e.g., the same number of PRBs. It should be understood that the use of four (4) sub-channels is only exemplary and each RB Set may include more or less sub-channels. It should also be understood that in the diagram of FIG. 4, the frequency may be considered to increase from left to right, e.g., the first PRBs of the sub-channel 0 are the lowest frequency PRBs and the last PRBs of the sub-channel 7 are the highest frequency PRBs within the resource pool 400. Again, since the PRBs are contiguous, the separation of the sub-channels does not include any unused PRBs. As described above, in this first option a sub-channel aligns with a resource pool boundary. This is shown in FIG. 4 as the start of the sub-channel 1 of the RB Set 410 aligning with the boundary of the resource pool 400 and the end of the sub-channel 7 of the RB Set 420 aligning with the boundary of the resource pool 400.

The resource pool 400 also comprises a guard band 430. Those skilled in the art will understand that a guard band is typically an unused part of the frequency spectrum between sub-channels that is used to prevent interference between the sub-channels, e.g., transmissions in sub-channel 3 of RB set 410 and sub-channel 4 of RB Set 420. However, in the first option, the end of the sub-channel 3 (e.g., the last PRBs) and the beginning of the sub-channel 4 (e.g., the first PRBs) are included in the guard band 430.

As described above, the first option may result in various issues for transmitting in the resource pool 400. For example, a sub-channel may extend across two (2) RB sets. This would mean that the UE 110 would need to perform Listen Before Talk (LBT) operations over two (2) RB sets for the transmission on this sub-channel. Those skilled in the art will understand that an LBT operation is used by the UE 110 in the unlicensed spectrum to determine whether the channel is clear for transmitting, e.g., the UE 110 will only transmit when the LBT operation determines that the channel is clear.

Another issue is that the PSCCH may be (partially) transmitted in the guard band. For example, consider the example of the sub-channel 3 of the RB Set 410, the number of remaining PRBs in the sub-channel 3 that are not in the guard band 430 may be less than configured number of PRBs for a PSCCH transmission. The UE 110 does not want to transmit the PSCCH in the guard band 430 because there is a greater chance that interference will cause the receiving UE to not properly receive the PSCCH transmission.

In some exemplary embodiments, to solve the issues related to the first option, several transmission rules may be applied. One exemplary transmission rule may be that for a sub-channel whose lowest PRBs are in a guard band, a PSCCH transmission may start from the lowest PRBs in the next RB set. In reference to FIG. 4, the sub-channel 4 of the RB Set 420 is a sub-channel whose lowest PRBs are in the guard band 430. Thus, if the UE 110 has a PDCCH transmission, the UE 110 will not transmit the PDCCH in sub-channel 4 and in RB Set 410 at all but wait for the lowest PRBs of the next RB Set, which are not shown in FIG. 4 as the next RB Set would be part of the next resource pool. In this example, if the UE 110 had a PSSCH transmission, that transmission may start on the first PRB of the sub-channel 4 that is in the guard band 430.

Another exemplary transmission rule may be that for a sub-channel whose highest PRBs are in the guard band, a PSCCH transmission stops at the last PRB in the RB set. In reference to FIG. 4, the sub-channel 3 of the RB Set 410 is a sub-channel whose highest PRBs are in the guard band 430. Thus, if the UE 110 has a PSCCH transmission, the UE 110 may start the PSCCH transmission on the PRBs of sub-channel 3 that are in the RB Set 410, but will not transmit the PSCCH in the PRBs of the sub-channel 3 that are in the guard band 430.

A further exemplary transmission rule may be that for a sub-channel whose middle PRBs are in a guard band, the PSCCH transmissions skip the PRBs in the guard band. FIG. 4 does not illustrate this example of a guard band in the middle PRBs of a sub-channel, thus FIG. 5 will be used for these purposes.

FIG. 5 shows an exemplary diagram 500 of an RB Set with contiguous PRBs having a guard band in the middle of a sub-channel of the RB Set according to various exemplary embodiments. In FIG. 5, the y-axis shows the sub-channel 510 (e.g., frequency) and the x-axis shows the slot 520 (e.g., time). As shown in this example, the guard band 530 may be in the middle of the sub-channel 510. The UE 110 may have a PSCCH transmission. Thus, following the rule described above where the PSCCH transmissions skip the PRBs in the guard band, the UE will begin transmitting the PSCCH on the lowest frequency PRBs of the sub-channel 510 (e.g., PSCCH 540). When the guard band 530 is reached (e.g., in frequency), the UE 110 will stop the PSCCH transmission and may transmit PSSCH 550 on the PRBs that are in the guard band 530. When the PRBs are no longer in the guard band 530, the UE 110 may continue transmitting the PSCCH 540 on the PRBs outside of the guard band 530.

As described above, some of the exemplary rules may result in the PSCCH transmission being stopped (e.g., when the highest PRBs of a sub-channel are in the guard band) or split (e.g., when middle PRBs of a sub-channel are in the guard band). In these cases, the PSCCH resource mapping should be addressed. In some exemplary embodiments, the PSCCH may be rate matched on the remaining PRBs and the symbols. In other exemplary embodiments, the PSCCH transmission is punctured on the PRBs in the guard band.

In the examples provided above for the first option, it was considered that the resource pool 400 was evenly divided by frequency into eight (8) sub-channels 0-7. However, there may be instances where the resource pool is evenly divided by frequency into sub-channels, but there are left over PRBs (e.g., residual PRBs). In the example of FIG. 4, these residual PRBs may be considered to be after the last PRBs of sub-channel 7 (e.g., higher in frequency). In this case, the residual PRBs are not used.

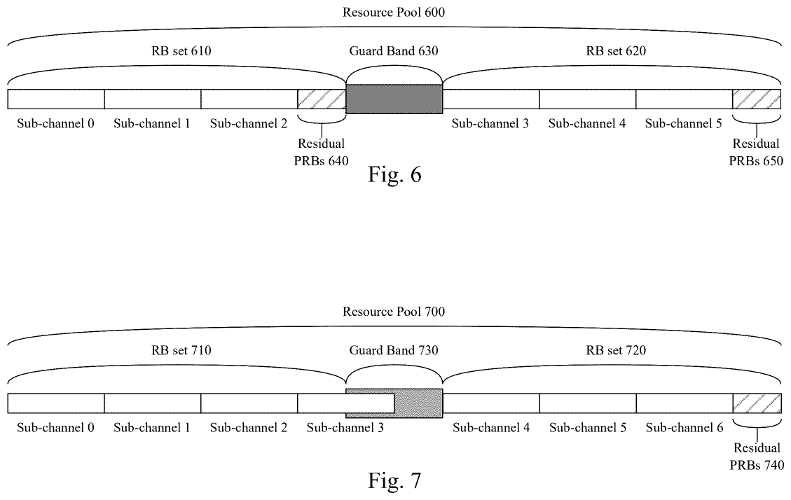

FIG. 6 shows a second exemplary option for mapping between sub-channels and PRBs in a resource pool 600 for sidelink communications in the unlicensed spectrum according to various exemplary embodiments. In the example of FIG. 6, sub-channels align with an RB set boundary. In each RB set, the mapping of a sub-channel starts from the first PRB of the RB set and is mapped sequentially within the RB set according to the sub-channel size.

As shown in FIG. 6, the resource pool 600 comprises two RB sets (e.g., RB Set 610 and RB Set 620) that may be considered to occupy contiguous PRBs and a guard band 630. As described above, in each RB set, the mapping of a sub-channel starts from the first PRB of the RB set and is mapped sequentially within the RB set according to the sub-channel size. Thus, the sub-channel 0 of the RB Set 610 starts at the first PRB of the RB Set 610. The sub-channels 1 and 2 of the RB Set 610 are of the same size (in frequency) as the sub-channel 0 and the sub-channels 0-2 occupy contiguous PRBs of the RB Set 610. However, as shown in FIG. 6, there are not enough residual PRBs 640 in the RB Set 610 to have a fourth sub-channel of the same size as the other sub-channels.

To complete the example, the sub-channel 3 of the RB Set 620 starts at the first PRB of the RB Set 620. The sub-channels 4 and 5 of the RB Set 620 are of the same size (in frequency) as the sub-channel 3 (and of the sub-channels 0-2) and the sub-channels 3-5 occupy contiguous PRBs of the RB Set 620. However, as also shown in FIG. 6, there are not enough residual PRBs 650 in the RB Set 620 to have a fourth sub-channel of the same size as the other sub-channels.

Similar to the first option, in the second option, the guard band cannot be used for PSCCH transmissions. Thus, one of the issues that arises for the second option is the waste of resources. For example, the residual PRBs in an RB set and PRBs in guard band are not used.

To resolve the issues of the second option, in some exemplary embodiments, the intra-cell guard band PRBs are not used and if the number of PRBs of one RB set cannot be divided by sub-channel size, the residual PRBs are not used. However, this rule may include exceptions. In a first exemplary exception, the highest sub-channel in the lower RB set may be extended. Referring to FIG. 6, the highest sub-channel in the lower RB set is sub-channel 2 of the RB Set 610. In this example, this exemplary exception would extend the sub-channel 2 to include the residual PRBs 640 and/or the PRBs of the guard band 630. It is noted that this would mean that the sub-channel 2 would no longer have the same size (in frequency) as the other sub-channels 0-1 of the RB Set 610. However, this exception then allows for PSCCH and PSSCH transmissions using the residual PRBs 640 and PSSCH transmissions using the PRBs of the guard band 630, thereby not wasting resources.

In a second exemplary exception, the lowest sub-channel in the higher RB set may be extended. Referring to FIG. 6, the lowest sub-channel in the higher RB set is sub-channel 3 of the RB Set 620. In this example, this exemplary exception would extend the sub-channel 3 to include the residual PRBs 640 and/or the PRBs of the guard band 630. It is noted that this would mean that the sub-channel 3 would no longer have the same size (in frequency) as the other sub-channels 4-5 of the RB Set 620. However, this exception then allows for PSCCH and PSSCH transmissions using the residual PRBs 640 and PSSCH transmissions using the PRBs of the guard band 630, thereby not wasting resources.

FIG. 7 shows a third exemplary option for mapping between sub-channels and PRBs in a resource pool 700 for sidelink communications in the unlicensed spectrum according to various exemplary embodiments. In the example of FIG. 7, sub-channels align with an RB set boundary. In each RB set, the mapping of a sub-channel starts from the first PRB of the RB set and is mapped sequentially within the RB set and/or guard band according to the sub-channel size.

As shown in FIG. 7, the resource pool 700 comprises two RB sets (e.g., RB Set 710 and RB Set 720) that may be considered to occupy contiguous PRBs and a guard band 730. As described above, in each RB set, the mapping of a sub-channel starts from the first PRB of the RB set and is mapped sequentially within the RB set and/or guard band according to the sub-channel size. Thus, the sub-channel 0 of the RB Set 710 starts at the first PRB of the RB Set 710. The sub-channels 1 and 2 of the RB Set 710 are of the same size (in frequency) as the sub-channel 0 and the sub-channels 0-2 occupy contiguous PRBs of the RB Set 710. However, as shown in FIG. 7, the sub-channel 3 starts in the RB Set 710 (e.g., immediately after the last PRB of the sub-channel 2) but extends into the PRBs of the guard band 730. This allows the sub-channel 3 to have the same size as the sub-channels 0-2.

To complete the example, the sub-channel 4 of the RB Set 720 starts at the first PRB of the RB Set 720. The sub-channels 5 and 6 of the RB Set 720 are of the same size (in frequency) as the sub-channel 4 (and of the sub-channels 0-3) and the sub-channels 4-6 occupy contiguous PRBs of the RB Set 720. However, as also shown in FIG. 7, there are not enough residual PRBs 740 in the RB Set 720 to have a fourth sub-channel of the same size as the other sub-channels.

Prior to discussing the issues of the third option, it should also be understood that instead of extending the sub-channel 3 of the RB Set 710 into the guard band 730, it may also be possible to have the residual PRBs be in the RB Set 710 and extend the sub-channel 4 of the RB Set 720 into the guard band 730 which would result in an extra sub-channel in the RB Set 720. The solutions provided below for the issues of the third option may be equally applied to this arrangement of the resource pool with minor modifications as would be clear to those skilled in the art.

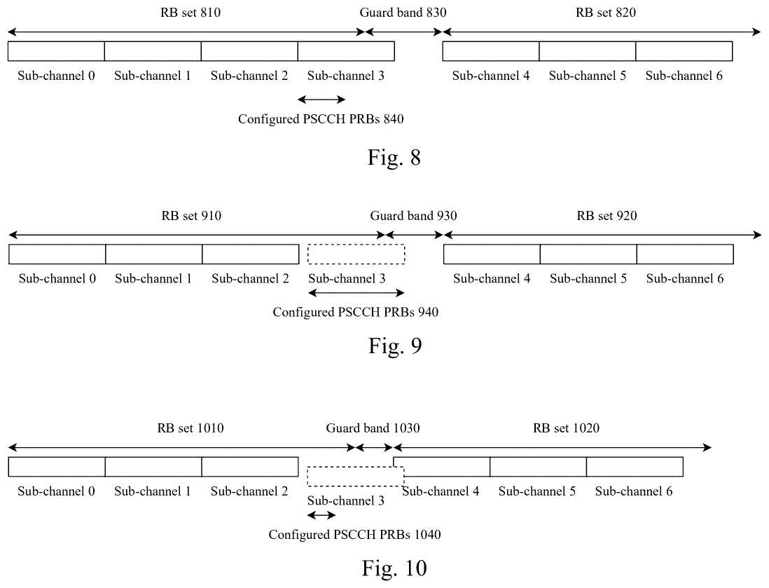

Similar to the above options, in the third option the guard band cannot be used for PSCCH transmissions. Some exemplary embodiments for addressing the issues with the third option will be described with respect to FIGS. 8-10.

FIG. 8 shows a first alternative 800 of the third exemplary option for addressing PSCCH transmissions in a guard band according to various exemplary embodiments. FIG. 8 shows the RB Set 810, the RB Set 820 and the guard band 830. It also shows the sub-channels 0-6 which are arranged in a similar manner as described above with reference to FIG. 7. For the purposes of this first alternative, only the sub-channel 3 is described as it is the sub-channel of interest.

Referring to sub-channel 3, in this exemplary embodiment, if the number of remaining PRBs in a RB set (e.g., RB Set 810) is larger than or equal to the configured number of PSCCH PRBs 840 and if the number of remaining PRBs in the RB set 810 plus the number of PRBs of the guard band 830 is larger than or equal to the configured sub-channel size, then the sub-channel 3 is composed of the remaining PRBs in the RB set 810 plus a number of PRBs of the guard band 830, such that the total number of PRBs of the sub-channel 3 is equal to the configured sub-channel size. Thus, in this example, since the configured number of PSCCH PRBs 840 does not extend beyond the boundary of the RB Set 810, it is acceptable that the sub-channel 3 does extend beyond the RB Set 810 into the guard band 830.

FIG. 9 shows a second alternative 900 of the third exemplary option for addressing PSCCH transmissions in a guard band according to various exemplary embodiments. FIG. 9 shows the RB Set 910, the RB Set 920 and the guard band 930. It also shows the sub-channels 0-6 which are arranged in a similar manner as described above with reference to FIG. 7. For the purposes of this first alternative, only the sub-channel 3 is described as it is the sub-channel of interest.

Referring to sub-channel 3, in this exemplary embodiment, if the number of remaining PRBs in the RB set 810 is smaller than the configured number of PSCCH PRBs 940 (e.g., the PSCCH PRBs would extend into the guard band 940), then the remaining PRBs in the RB set 910 are not used. Thus, in the example of FIG. 9, the sub-channel 3 is shown as a dashed box because there is no sub-channel 3 based on the rule defined in this second alternative.

FIG. 10 shows a third alternative 1000 of the third exemplary option for addressing PSCCH transmissions in a guard band according to various exemplary embodiments. FIG. 10 shows the RB Set 1010, the RB Set 1020 and the guard band 1030. It also shows the sub-channels 0-6 which are arranged in a similar manner as described above with reference to FIG. 7. For the purposes of this first alternative, only the sub-channel 3 is described as it is the sub-channel of interest.

Referring to sub-channel 3, in this exemplary embodiment, if the number of remaining PRBs in the RB set 1010 is larger than or equal to the configured number of PSCCH PRBs 1040, but the number of remaining PRBs in the RB set 1010 plus the number of PRBs of the guard band 1030 is less than the configured sub-channel size, then the remaining PRBs in the RB Set 1010 are not used. That is, even though the configured number of PSCCH PRBs 1040 would fit in the PRBs of the RB Set 1010, the sub-channel 3 size would be different (e.g., smaller) from the size of the other sub-channels 0-2 of the RB Set 1010. Thus, in the example of FIG. 10, the sub-channel 3 is shown as a dashed box because there is no sub-channel 3 based on the rule defined in this third alternative.

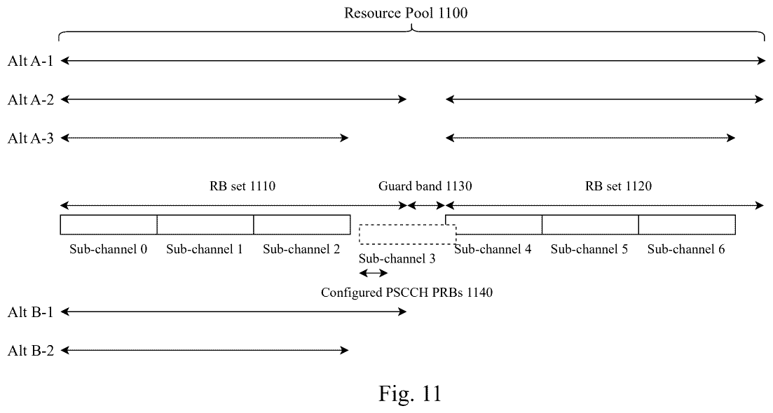

FIG. 11 shows an example of Physical Sidelink Feedback Channel (PSFCH) configuration information for a contiguous RB-based resource pool 1100 according to various exemplary embodiments. The resource pool 1100 comprises the RB Set 1110, the RB Set 1020 and the guard band 1130. It also shows the sub-channels 0-6 which are arranged in a similar manner as described above with reference to FIG. 7. The sub-channels 0-6 of FIG. 11 and the configured number of PSCCH PRBs 1140 are identical to the arrangement shown in FIG. 10 because applying the rule of FIG. 10 results in the same figure.

However, the purpose of FIG. 11 is to illustrate a manner of configuring PSFCH resources within the resource pool 1100. Those skilled in the art will understand that the resource pool 1100 may include PSFCH resources for the receiving UE to report information (e.g., ACK/NACK information) back to the transmitting UE. These PSFCH resources may be defined within the resource pool, e.g., in RB sets, in interlaces of an RB set, in dedicated PRBs of the RB set, etc. FIG. 11 indicates various manners of providing the configuration information for the PSFCH.

Initially, it should be understood that the PSFCH configuration information may include one or more bitmaps that identify the PSFCH resources within the resource pool 1100. The bitmap(s) may be provided in configuration information to the UE, e.g., Bitmap “sl-PSFCH-RB-Set” in the information element (IE) of “SL-PSFCH-Config” in sidelink resource pool (pre) configuration. These IEs are only provided as an example and it should be understood that the PSFCH configuration information may be provided to the UE using other IEs or other types of signaling.

In the exemplary embodiments, a single bitmap may be applied for the entire resource pool 1100 or there may be a bitmap for each RB Set (e.g., RB Set 1110 and RB Set 1120) within the resource pool 1100. The first set of alternatives of the bitmap are related to the example of a single bitmap being applied for the entire resource pool 1100, are illustrated on the top of FIG. 11 and are labelled Alt A-1 through Alt A-3.

In Alt A-1, the bitmap includes values for all the PRBs in the resource pool 1100, including the intra-cell guard band 1130. This is shown in FIG. 11 as the Alt A-1 line extending across the entire resource pool 1100. Thus, based on the bitmap in Alt A-1, the UE will understand which PRBs in the resource pool 1100 are available for PSFCH.

In Alt A-2, the bitmap only includes values for the PRBs in the RB sets (e.g., RB Set 1110 and RB Set 1120) of the resource pool 1100. This is shown in FIG. 11 as the Alt A-2 line extending across the entire RB Set 1110, skipping the guard band 1130 and then extending across the entire RB Set 1120. Thus, based on the bitmap in Alt A-2, the UE will understand which PRBs in each of the RB Sets 1110 and 1120 are available for PSFCH.

In Alt A-3, the bitmap only includes values for the PRBs corresponding to sub-channels in the RB sets (e.g., RB Set 1110 and RB Set 1120) of the resource pool 1100. This is shown in FIG. 11 as the Alt A-3 line extending across the RB Set 1110 until the end of sub-channel 2. As described above, in this exemplary embodiment, the sub-channel 3 does not exist because of the rule described above. Thus, the Alt A-3 line skips the PRBs of the RB Set 1110 that are not part of a defined sub-channel and also skips the guard band 1130. The Alt A-3 line then extends across the configured sub-channels of the RB Set 1120 but skips any residual PRBs that are not part of a defined sub-channel of the RB Set 1120. Thus, based on the bitmap in Alt A-3, the UE will understand which PRBs in each of the defined sub-channels are available for PSFCH.

The second set of alternatives of the bitmap are related to the example of a bitmap for each RB Set (e.g., RB Set 1110 and RB Set 1120) within the resource pool 1100, are illustrated on the bottom of FIG. 11 and are labelled Alt. B-1 through Alt B-2. In the example of FIG. 11, the Alt. B-1 and Alt B-2 are shown for the first RB Set 1110, but it should be understood that there will also be a bitmap that corresponds to the second RB Set 1120.

In Alt B-1, the bitmap includes all the PRBs in the RB set 1110 of the resource pool 1100. This is shown in FIG. 11 as the Alt B-1 line extending across the entire RB Set 1110. Thus, based on the bitmaps in Alt B-1, the UE will understand which PRBs in the RB Set 1110 are available for PSFCH. The corresponding bitmap (not shown) for the RB Set 1120 will provide the PSFCH information for the RB Set 1120.

In Alt B-2, the bitmap includes all the PRBs corresponding to sub-channels in the RB set 1110. This is shown in FIG. 11 as the Alt B-2 line extending across the RB Set 1110 until the end of sub-channel 2. As described above, in this exemplary embodiment, the sub-channel 3 does not exist because of the rule described above. Thus, the Alt B-2 line does not cover the residual PRBs of the RB set 1110. Thus, based on the bitmaps in Alt B-2, the UE will understand which PRBs in the defined sub-channels of the RB Set 1110 are available for PSFCH. The corresponding bitmap (not shown) for the RB Set 1120 will provide the PSFCH information for the RB Set 1120.

It should be understood that the PSFCH examples were provided above for the third alternative of the third option of the mapping between sub-channels and PRBs in a resource pool for sidelink communications in the unlicensed spectrum. However, the principles described by the examples for providing the PSFCH information may also be applied to the other alternatives of the third option and the first two options described above. Thus, the PSFCH configuration information may be applied to all the examples provided herein.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A method performed by a user equipment (UE), comprising:
receiving configuration information for a resource pool of a sidelink connection in an unlicensed frequency band, wherein the resource pool comprises a plurality of contiguous Physical Resource Blocks (PRBs), a first Resource Block (RB) set comprising a first subset of the PRBs, a second RB set comprising a second subset of the PRBs, and a guard band comprising a third subset of the PRBs; and
transmitting a Physical Sidelink Control Channel (PSCCH) transmission or a Physical Sidelink Shared Channel (PSSCH) transmission using the resource pool.

2. The method of claim 1, wherein the configuration information further comprises a plurality of sub-channels, wherein a mapping of the sub-channels for the resource pool starts at a first PRB of the resource pool and continues sequentially within the resource pool according to a configured size of each of the sub-channels.

3. The method of claim 2, wherein, when the PSCCH transmission is scheduled to start from a set of lowest frequency PRBs in one of the sub-channels and at least one of the lowest frequency PRBs comprise PRBs from the third subset, the PSCCH transmission is deferred until a next RB set.

4. (canceled)

5. The method of claim 2, wherein, when the PSCCH transmission is scheduled to include a set of highest frequency PRBs in one of the sub-channels and at least one of the highest frequency PRBs comprise PRBs from the third subset, the PSCCH transmission is stopped prior to the at least one of the highest frequency PRBs.

6. The method of claim 2, wherein, when the PSCCH transmission is scheduled to include a set of PRBs in one of the sub-channels and at least one of the PRBs comprise PRBs from the third subset, the PSCCH transmission is interrupted at a first of the at least one of the PRBs and continued after a last of the at least one of the PRBs.

7. (canceled)

8. The method of claim 2, wherein, when the configured size of the sub-channels results in residual PRBs that are not in any of the sub-channels, the residual PRBs are not used for PSCCH or PSSCH transmissions.

9. The method of claim 1, wherein the configuration information further comprises a plurality of sub-channels, wherein a mapping of sub-channels of the first RB set starts at a first PRB of the first RB set and continues sequentially within the first RB set according to a configured size of each of the sub-channels,
wherein a mapping of sub-channels of the second RB set starts at a first PRB of the second RB set and continues sequentially within the second RB set according to a configured size of each of the sub-channels,
wherein each of the first RB set and the second RB set comprise residual PRBs that are not included in any of the sub-channels.

10. The method of claim 9, wherein a highest frequency sub-channel of the first RB set is extended to include the residual PRBs of the first RB set or the PRBs of the guard band.

11. The method of claim 10, wherein the PSCCH transmission or the PSSCH transmission is scheduled for the residual PRBs of the first RB set or the PSSCH transmission is scheduled for the PRBs of the guard band.

12. The method of claim 9, wherein a lowest frequency sub-channel of the second RB set is extended to include the residual PRBs of the first RB set or the PRBs of the guard band.

13. The method of claim 12, wherein the PSCCH transmission or the PSSCH transmission is scheduled for the residual PRBs of the first RB set or the PSSCH transmission is scheduled for the PRBs of the guard band.

14. The method of claim 9, wherein the PSCCH transmission comprises a configured number of PRBs, and
wherein, when a number of residual PRBs in the first RB set is larger or equal to the configured number of PRBs of the PSCCH transmission and the number of residual PRBs in the first RB set and a first number of PRBs of the guard band is larger or equal to the configured size of the sub-channels of the first RB set, a further sub-channel of the first RB set is defined as the residual PRBs in the first RB set and a second number of PRBs of the guard band such that a total number of PRBs in the further sub-channel of the first RB set equals the configured size of the sub-channels of the first RB set.

15. The method of claim 9, wherein the PSCCH transmission comprises a configured number of PRBs, and
wherein, when a number of residual PRBs in the first RB set is less than the configured number of PRBs of the PSCCH transmission, the residual PRBs of the first RB set are not used for the PSCCH or PSSCH transmissions.

16. The method of claim 9, wherein the PSCCH transmission comprises a configured number of PRBs, and
wherein, when a number of residual PRBs in the first RB set is larger or equal to the configured number of PRBs of the PSCCH transmission and the number of residual PRBs in the first RB set and a number of PRBs of the guard band is less than the configured size of the sub-channels of the first RB set, the residual PRBs of the first RB set are not used for the PSCCH or PSSCH transmissions.

17. The method of claim 1, wherein the configuration information further comprises Physical Sidelink Feedback Channel (PSFCH) information, wherein the PSFCH information comprises one or more bitmaps indicating a location of PSFCH resources in the resource pool.

18. The method of claim 17, wherein the one or more bitmaps comprise a single bitmap applicable to all the PRBs in the resource pool.

19. The method of claim 17, wherein the one or more bitmaps comprise a single bitmap applicable to all the PRBs in the first and second RB sets of the resource pool.

20. The method of claim 17, wherein the configuration information further comprises one or more sub-channels of the first RB set and one or more sub-channels of the second RB set,
wherein the one or more bitmaps comprise a single bitmap applicable to all the PRBs in the one or more sub-channels of the first RB set and the one or more sub-channels of the second RB set.

21. The method of claim 17, wherein the one or more bitmaps comprise a first bitmap applicable to the PRBs in the first RB set and a second bitmap applicable to the PRBs in the second RB set.

22. The method of claim 17, wherein the configuration information further comprises one or more sub-channels of the first RB set and one or more sub-channels of the second RB set,
wherein the one or more bitmaps comprise a first bitmap applicable to the PRBs in the PRBs in the one or more sub-channels of the first RB set and a second bitmap applicable to the PRBs in the PRBs in the one or more sub-channels of the second RB set.
